(19) United States
(12) Patent Application Publication
(10) Pub. No.: US 2026/0093007 A1
(43) Pub. Date: Apr. 2, 2026

(54) System and method for tracking objects or batches within a work environment

(71) Applicant: Komete Smart Factory Made Easy Srl, Collebeato (BS) (IT)

(72) Inventor: Francesco Gaetarelli, Brescia (BS) (IT)

(21) Appl. No.: 19/113,967

(22) PCT Filed: Sep. 26, 2023
(86) PCT No.: PCT/IB2023/059528

§ 371 Date: Mar. 21, 2025

(30) Foreign Application Priority Data
Sep. 26, 2022 (IT) 102022000019734
Sep. 26, 2022 (IT) 102022000019737

(51) Int. Cl. G01S 5/06

(52) U.S. Cl. CPC G01S 5/06

(57) ABSTRACT

An automatic system for tracking an object or batch of products within a work area such as a yard or an industrial building includes at least one emitter asset tag that can be uniquely associated with the object or batch of products, at least one device having at least one receiving unit defining a first action area, and a central unit operably connectable with the at least one device. When the emitter asset tag is within the action area, the central unit detects the presence of the at least one emitter asset tag.

### FIELD OF APPLICATION

The present invention is generally applicable in systems for tracking the location of objects or batches of products within a work environment such as a manufacturing plant, industrial building, yard, warehouse or the like.

### STATE OF THE ART

In industry, the need for tracking products and objects within work environments such as production plants, warehouses and yards is well known.

This need is necessary for the implementation of modern production efficiency techniques that are becoming the most important tool for reducing production time and costs.

By object is meant any object used in an industrial environment, such as tools, drills, torque wrenches, drawers, tool cabinets, testers, paper work orders or molds and equipment, while by batch of products is meant a set of products, preferably the same, placed in a container or on a stand such as a box, pallet, crate, or the like.

For this purpose, there are systems that involve a plurality of stationary detectors, e.g., cameras attached to walls, roof, and/or pillars.

A drawback of such systems is that they require a thorough preliminary study to determine the location of fixing the cameras in the industrial building.

Further drawback of such systems is to require such a study every time there is a change in the configuration of the working environment, such as when a machine is moved or a machine is added.

Such preliminary studies often have a long duration, quantifiable in weeks or months, and have high costs. Moreover, after the preliminary study is completed, it is necessary to proceed with the installation phase of such a system, which requires substantial resources both in terms of money and specialized know-how and, most importantly, requires plant downtime.

Disadvantage of such systems is therefore that they require a high expenditure of time and money for their preparation and commissioning.

For these reasons, i.e., the long activation time, high cost and lack of flexibility, such systems are sparsely used in industrial settings, so objects or batches are generally not tracked or located within the hall.

In addition, known systems, and particularly those employing cameras, require specific image identification software that is particularly expensive and relatively reliable.

### PRESENTATION OF THE INVENTION

The purpose of the present invention is to overcome at least partially the above-mentioned drawbacks by providing a system for tracking an object or lot in a work environment having characteristics of high functionality and low cost.

Another purpose of the invention is to make available a particularly versatile object or lot tracking system.

Another purpose of the invention is to make available an object or lot tracking system that can be positioned in any work environment.

These purposes, as well as others that will appear more clearly below, are achieved by a method and system for tracking a lot in accordance with what is described and/or claimed and/or illustrated herein.

Advantageous forms of realization of the invention are defined in accordance with dependent claims.

Such purposes are achieved by a system comprising at least one emitter associated with the object or lot, and one or more devices each comprising at least one receiving unit so as to define an area of action within which the emitter is identified.

According to a particular aspect, the system may comprise a plurality of devices each having its own area of action so that the sum thereof defines a surveillance area within which the emitter is identified.

According to a further aspect, shielding components may be provided to select the extent of the area of action of one or more of the devices so as to vary the surveillance area.

According to a further aspect, one or more of the devices may comprise a plurality of receiving units so as to select the extent of the area of action and thereby vary the surveillance area.

According to a further aspect, the device may be mounted on a repositionable structure so that the surveillance area may be varied by repositioning the device.

### BRIEF DESCRIPTION OF THE DESIGNS

Further features and advantages of the invention will become more apparent in light of the detailed description of a preferred but not exclusive form of embodiment of the invention, illustrated by way of non-limiting example with the aid of the accompanying drawing plates in which:

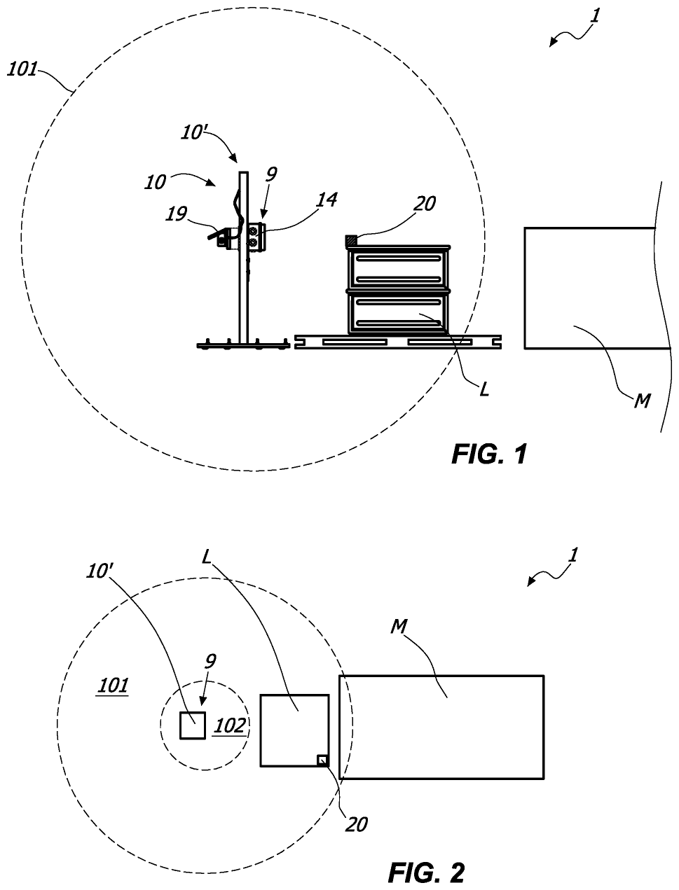

FIGS. 1 and 2 are a schematic view of a system 1 for determining the presence of a batch of products in a work area 100 with a turret 10′ in close proximity to a processing machine M;

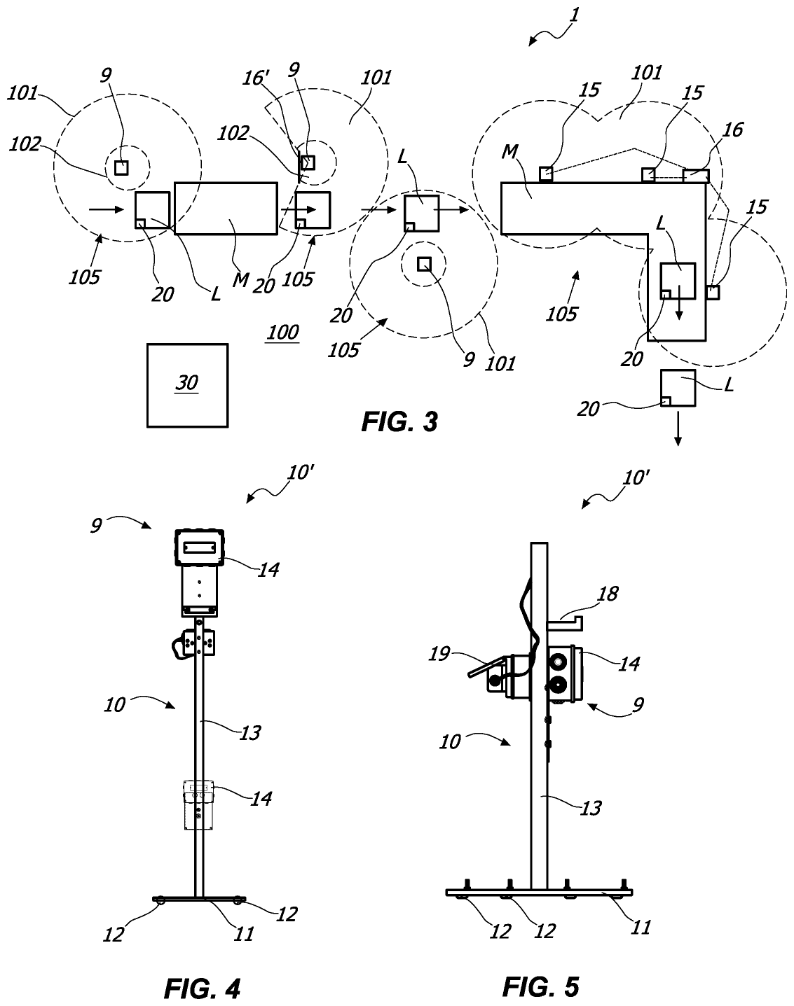

FIG. 3 is a schematic view of a system 1 with a plurality of devices 9;

FIGS. 4 and 5 are side views of different forms of turret implementation 10;

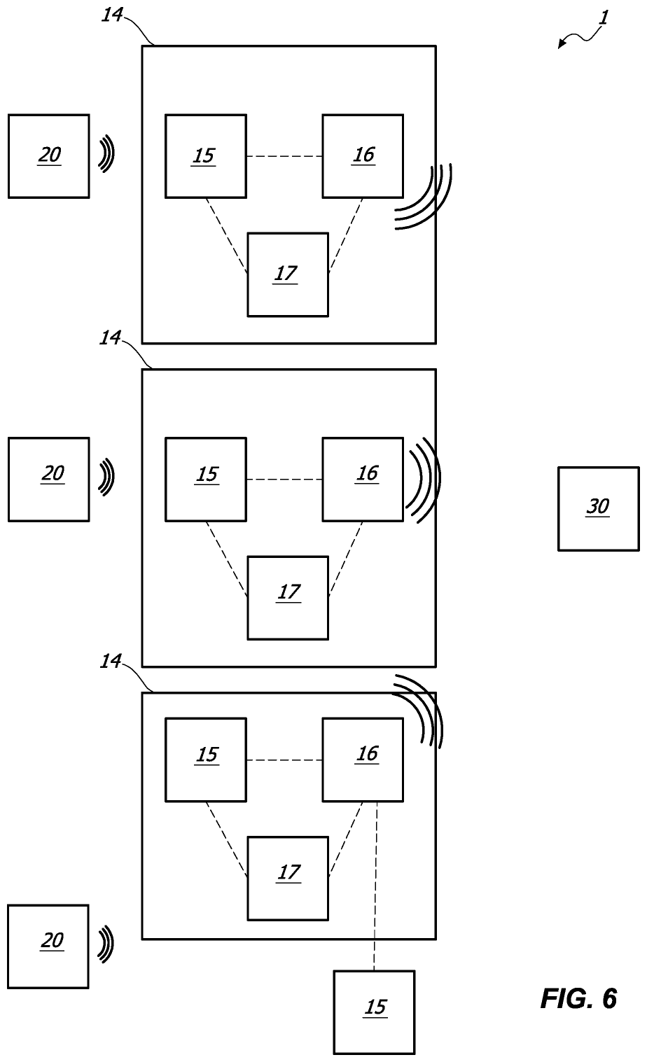

FIG. 6 is a schematic view of the operation of system 1;

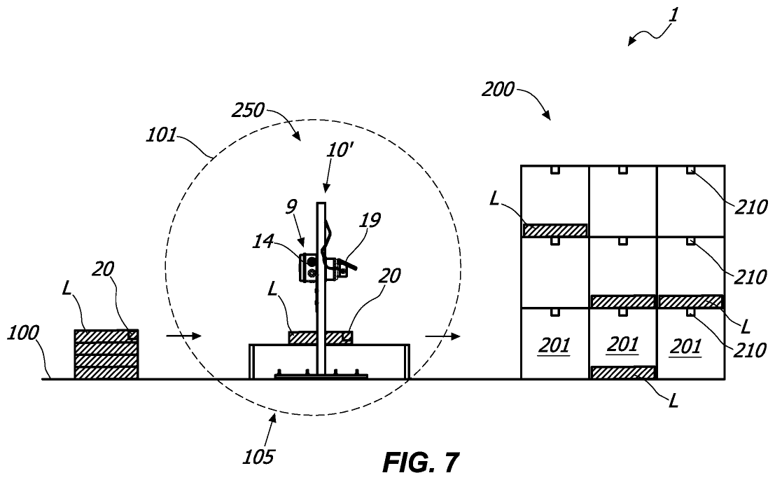

FIG. 7 is a schematic view of a system 1 for determining the location of a lot in a warehouse 200.

### DETAILED DESCRIPTION OF SOME FAVORITE EXAMPLES OF IMPLEMENTATION

Referring to the above figures, we describe a system 1 for determining the position of an object or lot L of products within a work area. The latter may be an enclosed space, such as an industrial building, or an open space, such as a yard.

Essentially, as further described below, the system 1 will be able to enable detection of the presence or absence of the object or batch of products L in a surveillance area 105 within the work area 100.

It is understood that the surveillance area 105 may be a part of or may coincide with the work area. For example, the surveillance area may be only an area of the industrial building, or only the warehouse or the outside yard.

In what follows, reference will be made to the tracking of an L lot, for example, a box or pallet. It is understood that System 1 may be configured to track any lot or object.

Appropriately, system 1 may include one or more action areas 101 within work area 100. In particular, the system may be configured to detect the presence of lot L within each of the action areas 101. In this way, the system will be able to identify in which action area 101 lot L is present, i.e., the location of lot L.

Such action areas 101 could, for example, be areas in the vicinity of M processing machines or processing areas. In this way, it will be possible, for example, to determine in the vicinity of which M machine (or processing area) Lot L is present, and thus the location of Lot L in work area 100.

The sum of these action areas 101 will be able to define the surveillance area 105. In case a single device is present, the single action area 101 may coincide with the surveillance area 105.

According to a particular aspect of the invention, system 1 will be able to store the different locations of the L lot detected over time.

Thanks to this feature, it will be possible to trace the history of the latter, i.e., for example, the path in the work area. For example, it will be possible to track the entire processing of the batch, how long it stops at a machine, how long it remains in a warehouse, or the like.

According to a particular aspect of the invention, the system will always be able to detect the presence of batch L in the work area while not determining its location. In other words, system 1 will be able to always allow detection of whether batch L is in the work area and will be able to allow determination of its location when it is within surveillance area 105.

With this feature, it will be possible to configure system 1 so that action areas 101 include only particular locations of interest where it is relevant to know when the lot is present. In other words, it will be possible to limit the number of action areas 101 and thus devices 9 making the system effective and at the same time economical.

Eventually, system 1 will be particularly suitable for tracking lot L in a warehouse 200, that is, to enable the location of lot L within warehouse 200 to be determined.

More specifically, system 1 may comprise at least one signal emitter 20 and at least one receiver unit 15.

Preferably, system 1 may comprise at least one device 9 that may comprise at least one receiver 15.

In a manner in itself known, sending the signal from the emitter 20 may correspond to sending a data packet that may then be received by the receiving unit 15. The latter may be, for example, an antenna.

Emitter 20 may be associated with a lot of products, L, preferably in a unique manner. In this way, the identification of emitter 20 may correspond to the identification of lot L.

Emitter 20 may be a so-called asset tag. An example of an asset tag is a device that implements Bluetooth Low Energy, Ultra Wide Band, Active Rfid, Wifi technology.

Preferably, the emitter may be a beacon 20 and may employ BLE (bluetooth low energy) technology. In this way, beacon 20s may be of known types found on the market and may have a particularly low cost and high autonomy.

In the following for convenience, only beacon 20 will be described as an asset tag without limiting it exclusively to this form of implementation.

Receiving unit 15 may be configured to receive signals, i.e., data packets, sent by beacon 20.

Appropriately, a logical unit 16 operatively connected with the receiving unit 15 may be provided. The logical unit 16 will be able to determine the power of the beacon received by the receiving unit 15.

Advantageously, the logic unit 16 will be able to determine whether the signal strength is above or below a predetermined threshold value. Appropriately, this predetermined threshold value will be able to define the action area 101. In fact, when the signal has a value above such a threshold value Logic Unit 16 will be able to process that beacon 20 is within action area 101, and thus the presence of lot L in such action area 101.

In other words, each device 9 will be able to include at least one receiver 15 and logic unit 16 configured with a threshold value predetermined to predetermine action area 101.

Advantageously, this threshold value may be selectable by an operator so as to predetermine the extent of action area 101. Different devices 9 may then have action areas 101 of different extents.

The action area 101 may then be a space of substantially spherical shape with a center at the receiving unit 15 and a range defined by the predetermined threshold value of the signal. Such a situation may occur in the case of open spaces.

According to a particular aspect of the invention, the range 101 may have different extent depending on the operator's preference.

For example, depending on the configuration of the work environment, the action area 101 may have a non-spherical extent due to the presence of other processing machines obstructing the beacon 20 signal.

Eventually, there may be shielding panels 16′ acting on the receiving unit 15 to shield the latter in a predetermined manner. For example, a plate 16′ may be provided.

In this way, as for example schematically shown in FIG. 3, the extent of the action area 101 may be determined.

For example, in case the receiver unit is interposed between two machines, one side of the receiver 15 may be shielded so that its action area 101 covers only one of the two machines, i.e., so that the signal receiving the receiver 15 from the beacon 20, in proximity of either on of the two machines is below the threshold value and the signal receiving from the beacon 20 in proximity of the other machine is above the threshold value.

Eventually, regardless of the above, a device 9 may comprise a plurality of receivers 15 all connected to the same logical unit 16. In this way, as schematically illustrated in FIG. 3, the action area 101 of such a device 9 may have an extent equal to the sum of the reception areas of the receiving units 15.

In other words, the individual action area 101 of each device 9 may have a different extension. Such extension of the area 101 of each device 9 may be configured by the operator, i.e., it may be determined by the operator by means of the shielding means 16′ and/or by the arrangement of multiple receivers 15 and/or by varying the threshold values.

Due to this feature, the surveillance area 105 will be able to be predetermined to have variable shaping and extension as needed.

In fact, surveillance area 105 will only be able to be a part of work area 100. For example, only a part of the hall, yard, or only the area in the vicinity of a production line, or the like, may be surveilled. For example, surveillance area 105 may be an area within work area 100 in the transit of lot L to be plotted.

In this way, it is not necessary to monitor the entire work area 100 while still maintaining high surveillance effectiveness and thus enabling the tracking of batch L.

Furthermore, thanks to the above, overlapping areas 101 that would result in the simultaneous presence of lot L in two locations can be avoided.

A further advantage of the above is to allow tracking of L lots even in the case of small workplaces and/or with special configurations. Indeed, in such a case it will be sufficient to determine action areas 101 of appropriate extension and shaping so that surveillance area 105 covers the areas of interest in that work environment.

The surveillance area 105 can be determined quickly and easily, possibly it can be determined on site.

Because of this feature, it will be possible to set up the system 1 and install it on-site depending on the configuration of the work area 100 without the need for preliminary studies.

Operationally, one or more devices 9 may then be arranged, preferably a plurality thereof, which may be placed in the work area 100 in any mode at the location of interest to be monitored.

Eventually, one or more of the devices 9 may be configured, i.e., the extent of the respective action area 101 and/or 102 may be determined as described above.

Then the devices 9 can be operationally connected with the central unit 30 which will begin to constantly receive data regarding the location in the surveillance area 105 and/or the presence of the asset tag (and thus the lot) in the area 100.

In case it is necessary to change the extent of area 105, e.g., due to machine change, it will be sufficient to reposition one or more of the devices 9, add one or more of the devices 9, and/or change the configuration of one or more of the devices 9.

System 1 is thus easy to install and particularly versatile.

Appropriately, a support structure 10 may be provided for the device 9 and/or receiver 15.

It is understood that in the case where the device 9 comprises a plurality of receivers 15, the support structure 10 may be suitably configured in a self-known manner. On the other hand, the support structure 10 may be configured to support the single device 9 or a plurality of devices 9. For example, it may be a truss extending along a production line.

Preferably, each structure 10 will be able to support a single device 9.

The support structures 10 will be able to be easily positioned in the work area 100 so that the devices 9 are in predetermined positions. Advantageously, the surveillance area 105, defined by the sum of the action areas 101 of the devices 9, can then be determined on site quickly and easily, and can be adapted to the configuration of the work environment 100.

The support structure 10 will be able to be placed at any position in the work area 100. Support structure 10 will be able to be self-supporting.

Thus, advantageously, there is no need to attach devices 9 or receivers 15 to fixed structures such as uprights, ceilings, or trusses as in known systems.

Furthermore, advantageously, the time for placing the support structures 10, and thus for installing the system 1, may be particularly reduced.

Thanks to this feature, system 1 will also be able to be installed in enclosed areas or outdoors, and in areas without roofs or trusses, such as in yards. In addition, System 1 will be able to be particularly safe in that, for example, it does not require the placement of structures at high heights or suspended above work areas where users transit. Finally, because of the above, system 1 will be able to be particularly quick to install as support structures 10 can be placed as desired on the floor of the industrial building or yard.

Preferably, the support structure 10 will be able to be movable in the work area 100 to enable an easy reconfiguration of system 1. For example, it will be able to be movable between at least a first and a second operating position within the same work area 100 to facilitate a reconfiguration of system 1.

Thanks to such a feature during installation, the support structure 10 or plurality thereof can be easily moved and reconfigured so that the corresponding surveillance area 105 covers the areas of interest desired by the user.

Moreover, because of this feature, it is not necessary to make a study of the configuration of the work area 100 and the positioning of the machinery M in it to calculate the position of the receivers 15 and thus the support structures 10. In fact, one or more support structures 10 can be arranged and moved into the workspace 100 at any position.

Operationally, therefore, the operator will be able to go to the work area 100 with a plurality of support structures 10, will be able to position the latter within the work area 100 depending on the configuration of the latter.

For example, one will be able to vary the number and location of support structures 10 depending on the spatial extent of the work area 100, the number shape and/or type of machinery M, user preferences such as guarding a particular passage area or guarding an area where lots or objects should not be placed.

With the ability to move the devices 9 one can easily change the position of the action areas 101 and thus the extent of the surveillance area 105, i.e., one can reconfigure the system 1.

In fact, the movement of support structures 10, in addition to the advantages described above with reference to the installation of system 1, will be able to allow one or more support structures 10 to be repositioned at will.

In this way, in case there is the movement of a machinery M within the work area 100 it will be possible to simply move the support structure 10 (i.e., the device 9 with its associated area of action 101) close to it.

Similarly, in the event that a machinery M is replaced one will be able to move the support structure 10 so that the latter's action area 101 allows it to supervise a desired area of the work area 100, such another machinery.

Because of what has been described above, System 1 will be able to be particularly versatile in terms of both installation and subsequent use and possible reconfiguration.

Appropriately, during the operation of the system the receivers 15 or devices 9 may be essentially stationary. In other words, movement of the receivers 15 or devices 9 will be able to occur between different working positions to allow reconfiguration of the surveillance area 105.

In fact, in general, it is the asset tag 20 that moves through the work area while the devices 9 and/or receivers 15 may be substantially stationary.

Appropriately, the support structure 10 may include a base portion 11 that may be intended to contact the ground of the work area 100. Preferably, the base portion 11 may include a base plate and a plurality of feet, casters, or the like.

The support structure 10 may have a configuration such that it can be easily handled by one or more operators. For example, it may have a weight of less than 25 kg and/or may include means to promote its movement in the work area 100, e.g., handles.

Possibly, means 12 may be provided to promote the handling of the support structure 10. For example, such means 12 may comprise feet or one or more casters of a type known per se and/or may comprise handles.

According to a particular aspect of the invention, there may be provided a so called “turret”(device support structure) 10′ comprising the support structure 10, as for example illustrated in FIG. 4 and FIG. 5. In such a case, the support structure 10 may include a base 11 intended to remain facing the floor of the work area 100 with a plurality of support feet 12. Where appropriate, such feet 12 may be adjustable.

The support structure 10 may further comprise a post 13 extending from the base plate 11 substantially perpendicular thereto.

The support structure 10 may support the device 9 or the receiver 15.

Preferably, the support structure 10 may include a support portion for the receiver 15. Preferably, the turret 10′ may include a case 14 that may be attached with the pole 13, preferably at the end thereof opposite the end attached with the base plate 11.

The device 9 may include such a case 14.

It is understood that case 14 will be able to vary its distance from the floor. This will allow the area of action 101 to be varied. For example, in the case of Lot L being moved on the ground the case 14 may be near the floor, such as at the bottom of the pile 13, while for example in the case of Lot L being moved overhead, such as with an overhead crane or on a work surface, the case 14 may be at the top end of the pile 13 so as to have the maximum distance from the floor.

It is understood that poles 13 of different heights and/or telescoping may be provided so that the length of pole 13 and thus the height of support structure 10 may be varied.

Advantageously, such variation in the length of the pole 13 may be selectively performed by the user so that the same support structure 10 may be employed in different configurations.

Preferably, the case 14 will be able to contain the receiver unit 15. Preferably, the case 14 will be able to contain additional parts of a type known in itself to enable the operation of the system 1. For example, the case 14 may include a power supply or battery for the receiving unit 15, a storage unit for data received from the receiving unit, and/or a logic unit 16 to process and/or send such data. Such components may be of a type known per se.

According to a particular aspect of the invention, the receiver 15 may be a separate piece from the logic unit 16. The latter may be connected to each other by a connector. In other words, the antenna 15 may not be printed on the same board as the logic unit 16.

Due to such a feature, as for example schematized in FIG. 3 and FIG. 6, the device 9 may comprise multiple receivers 15 that may be placed inside the case 14 and/or outside the case 14.

The case 14 may be enclosed, preferably hermetically sealed so as to be used in heavy duty areas 100.

For example, the case 14 may have an IP55 degree of protection according to EN60529 or other similar standards.

Preferably, the turret 10′ may then comprise the support structure 10 and receiver 15 and the sending module and/or logic unit 16. More preferably, the turret 10′ may comprise the support structure 10 and the device 9.

The turret 10′ may also comprise a rechargeable battery or may be connected to the power supply.

Eventually, a system 1 may include rechargeable, i.e., stand-alone, and mains-powered turrets 10′ depending on the configuration of the work area 100.

Thus, advantageously, in the event that an area to be monitored is difficult to reach by power supply or the passage of electrical cables is impossible due to safety regulations, it will still be possible to monitor that area.

In addition, the use of 10′ turrets with rechargeable batteries will be particularly suitable for use in areas that need to be monitored occasionally, for example for two or three weeks.

Although the system 1 may comprise a single turret 10,′ preferably the system 1 may comprise a plurality of turrets 10′, each having its own receiving unit 15 or device 9, and a respective area of operation 101.

System 1 may be operationally connectable with or may comprise a central unit 30.

Suitably, the central unit 30 may comprise or may consist of a storage unit and/or a data processing unit.

The central unit 30 may be operatively connected with the devices 9. In particular, the logical unit 16 of each device 9 may be operatively connected with the corresponding receiver unit 15 (or with the plurality of receivers 15 if there are any) and the central unit 30.

The operational connections of the central unit 30 with the logical units 16 may be made by cable or, preferably, they may be wireless. In the latter case, advantageously, it may be particularly easy to move the devices 9, e.g., the turrets 10′ into the work area 100 and thus to install the system 1 and the subsequent configuration changes thereof.

Appropriately, the logical unit 16 may include a data-sending module of a type known in itself to send data to the central unit 30. The data may be sent in real time or in packets with a predetermined time interval that may be short, say on the order of 5 minutes, medium, say on the order of 60 minutes, or long, say every 8 hours or every 2 hours. In the latter case, advantageously, it will be possible to send data when M machines are stopped avoiding possible interference.

Logic unit 16 can be configured to send 30 data to the central unit regarding:
presence or absence of the beacon 20 within the respective action area 101;
an identification code of beacon 20 if present;
an identification code of the receiving unit 15 or device 9;

It is understood that additional data referring to environmental characteristics (e.g., temperature, humidity) or operating characteristics (e.g., battery charge level) may be transmitted.

Possibly such data sent from logical unit 16 may include an identification of the location of receiving unit 15 (or device 9) in working area 100. For example, device 9 may include a gps module operationally connected with logical unit 16. This configuration may be particularly advantageous in the application of system 1 in the case of outdoor and/or particularly large working environments such as a yard.

The central unit 30 will be able to collect data from all logical units 16. Advantageously, the central unit 30 will be able to process this data to determine the logical unit 16 that detected beacon 20, and thus the location of beacon 20 and thus of lot L.

Appropriately, central unit 30 will also always be able to detect whether beacon 20 is in the work area even without identifying its location. In fact, at least one receiving unit 15 of the devices 9 arranged in the work area will be able to detect the signal of beacon 20 even if it is below the threshold value that determines the action area 101.

This data, together with the identifier of the beacon 20, can be sent to the central unit 30.

Advantageously, in this way, the system will always be able to enable it to know whether the beacon 20 is inside the work area even if it is outside the surveillance area 105.

Advantageously, moreover, by storing such data in the central unit 30, it will be possible to track the lot L.

In fact, a plurality of positions occupied over time by the lot L within the surveillance area 105 can be determined, thus tracking its movements.

It is understood that the central unit 30 will be able to determine the location of lot L automatically due to the geolocation data. On the other hand, in the absence of the geolocation system, the central unit 30 will be able to store or collect additional data related to the position of the receivers 15 or devices 9, for example, the position of the turrets 10′, and will then be able to process such stored or collected data with the data received from the logic units 16 to determine the position of the lot L.

According to a particular aspect of the invention, device 9 will be able to define a second action area 102 having a different extent from action area 101. More specifically, such an action area 102 may have significantly smaller extension than the action area 101.

For example, action area 101 may have an open-space range of about 150 cm to 3000 cm, while action area 102 may have an open-space range of less than 30 cm.

Appropriately, the logical unit 16 may send to the central storage unit 30 data containing information about:
presence or absence of the beacon 20 within the action area 102;
an identification code of beacon 20 if present;
an identification code of the receiving unit 15;
possibly, the location of the receiving unit 15.

The range of area 101 and the range of area 102 may be determined by means of two different power thresholds of the same signal received by the receiving unit 15. In such a case when the signal strength detected by the receiving unit 15 is to be greater than a first threshold value the beacon 20 may be in the action area 101, and when it is greater than a second threshold value the beacon 20 may be in area 102.

It is understood that such threshold values of area 101 and/or area 102 may be significantly different depending on the size of the object and/or lot L to be tracked, e.g., whether it is a drill, a mold, a beam, a box, a container, depending on the working environment, e.g., open yard or closed industrial building.

In any case, as described above, the area 101 and/or 102 of each device 9 may differ in extent due to interference from nearby machinery, e.g., if there are nearby presses, extruders, or the like that obstruct signal propagation, and/or due to the operator's determination of the threshold value and/or the use of shielding means and/or the number of receivers 15 of each device 9.

According to a particular aspect of the invention, the radii of action of areas 101 and/or 102 may be predeterminable. Preferably, they may be determined during installation and/or may be selectively changed by the user. Eventually, one or both of these radii of action of the areas 101, 102 may be modified in the case of movement of the support structure 10, for example in the case of moving the turret 10′ into the work area 100.

Possibly, input means 19 may be provided to allow the user to determine the extent of action areas 101 and/or 102. In this way, one will be able to position device 9 (or devices 9) and determine the extent of the respective area 101 and/or 102.

For example, one will be able to vary the reception power threshold value of area 101 and/or 102 to which the variation of the range of area 101 and/or 102 may correspond and consequently the variation of the extension of action area 101 and/or 102.

Appropriately, the second threshold value may be greater than the first threshold value.

Input means 19 may be operationally connected with logical unit 16.

Input means 19 will be able to be connected with logical unit 16 by cable or wirelessly. For example, input means 19 may be provided at each device 9. For example, input means 19 may be a touch screen or other means of a type known in itself.

Possibly, the input means 19 may be operationally connected with the central unit 30 so that these threshold values are determined remotely.

Preferably, the support structure 10 or turret 10′ may support such input means 19. For example, a touch screen 19 attached to the pole 13 of the turret 10′ may be provided.

Appropriately, the support structure 10 may include a seat 18 to house the beacon 20. The seat 18 and the receiving unit 15 may be mutually configured so that when the beacon 20 is in the seat 18 the former is within the area 102.

For example, the support structure 10 may include a pocket or shelf defining the seat 18. The shelf 18 may be attached to the pole 13 in any position, preferably near the case 14. The distance between the seat 18 and the receiving unit 15 may then be less than range of the area 102.

Preferably, turret 10′ may be positioned so that when beacon 20 is associated with lot L, for example, inside the case, beacon 20 is inside area 101 and outside area 102, while when beacon 20 is positioned in location 18, beacon 20 may be inside area 102.

Thanks to the above, it will be possible to determine when beacon 20 is on turret 10 and no longer on lot L (i.e., the beacon is inside area 101 and outside area 102). Such a situation may correspond to the processing situation of the products on lot L, or to a break situation, or other.

Eventually, the central unit 30 may include or be operatively connected with a data processing logic unit to process the received data in order to provide the user with indications of the location of the batch L and/or the status (processing, pause, transfer, or other) and/or the tracking of the same L (e.g., the path from the entrance into the work area 100).

Possibly, the central unit 30 may be at one of the devices 9, e.g., a movable structure may be provided that can be positioned in the work area to support a computer that includes the central unit 30. Preferably, the central unit 30 may be within the control offices. For example, central unit 30 may be a computer within those offices and connected wirelessly with devices 9.

In what follows, reference will be made to devices 9 mounted on turrets 10′. However, it is understood that system 1 may equally be installed by arranging a plurality of devices 9 and attaching them to structures or machines already in the work area or on different support structures 10.

Operationally, a plurality of turrets 10′ may be arranged, they may be transported to the work area 100, the turrets 10′ may be placed on the floor, and they may be moved to a plurality of predetermined positions, such as in close proximity to the machines M so as to define the surveillance area 105 comprising all positions of interest covered by the action areas 101.

The 10′ turrets may then be operationally connected with the central unit 30 either by cable or wirelessly so that the latter receives data from the former, and in particular coming from the logic unit 16.

It is understood that the wireless connection will be able to allow greater freedom of action and may facilitate the handling of the 10′ turrets. In case there is a need to move one or more 10′ turrets, it will be sufficient for the operator to grab a 10′ turret and move it to a new position.

The position of the turrets 10′ in the work area 100 may be automatically detected by the central unit 30.

In this case, the 10′ turrets may be geolocated in a way in itself known, for example, by means of a gps sensor.

On the other hand, the location of the turrets 10′ may be stored in the central unit 30 and/or may, preferably, be entered into the central unit 30 manually by the operator once the turrets 10′ have been placed in the desired location.

According to a particular embodiment of the invention, the system 1 may determine the location of the batch L of products within a work area 100 comprising a warehouse 200. Preferably, the warehouse 200 may comprise a plurality of storage locations 201 for one or more batches of products L.

The warehouse 200 may be a racking system having a plurality of compartments. For example, it may be an automated warehouse of a type known in itself. Eventually, the warehouse 200 may have a substantially planar development, e.g., it may be a yard with a plurality of areas to house one or more lots that may then define the locations 201.

As further described below, the warehouse 200 may have vertical and/or horizontal development, e.g., it may include both a yard and a rack, and in general it may have any shape and/or extension.

It is understood that the warehouse 200 may be a long-term storage area, or it may be an area of the work area 100 intended to temporarily store the object or lot such as, for example, a so-called process warehouse, an on-board storage area, an object or lot accumulation area interposed between two processing stations, or in general any area of the work area 100 intended to accommodate the object or lot to be tracked that provides for a plurality of storage locations.

The system 1 may essentially comprise a plurality of sensors 210 to detect the free or occupied status of one or more, preferably all, of the stations 201. Thus, it is then possible to detect the presence or absence of the lot L at one or more of the locations 210, preferably at each of the locations 210.

The sensors 210 may preferably be ultrasonic sensors. In this way such sensors can be particularly inexpensive and a large number of sensors can be arranged. Also in this way a large number of 210 locations can be defined.

Appropriately, a station will be able to accommodate a single object or batch L. In addition, by using inexpensive sensors, system 1 will also be able to be used for small objects or batches L and/or large warehouses 200.

System 1 will be able to include at least one station 250 for lot L identification.

Appropriately, it will then be possible to identify the lot L of products to be stored and detect the change in status from free to occupied of one of the stations 201. In this way, the location of lot L can be determined.

With such a feature, the system will be able to enable the location of Lot L to be determined accurately and economically at the same time. In fact, it will be possible to employ a small number of stations 250, possibly a single station 250, which have a high cost, and a large number of ultrasonic sensors 210, which have a low cost.

Preferably, station 250 may be in a spatial relationship with warehouse 200 such that lot L first encounters station 250 or one of stations 250 and then is placed at one of stations 201.

Advantageously, station 250 may be placed in any position. In fact, the latter and the 210 sensors can be operationally connected by cables, or preferably wirelessly. In the latter case, the position of station 250 can be easily placed or varied.

Eventually, a central unit 30 operatively connected with station 250 and sensors 210 may be provided to process data received from the latter and/or station 250 to determine the location of lot L in the warehouse.

Further advantage of system 1 is thus to allow station 250 to be placed according to preference and not necessarily in close proximity to warehouse 200. For example, station 250 may be placed at the entrance to the industrial building or yard or near the goods unloading area or other locations. On the other hand, station 250 may be placed in the vicinity of warehouse 200, for example, it may be on the rack or on the floor in the yard.

Possibly, one or more of the stations 250 or the single station 250 may be mobile.

Thus, advantageously, one or more of the stations 250, or the single station 250, can be easily placed in the work area 100 and can then be moved as needed. For example, station 250 or the plurality of stations 250 could be moved in the event of reconfiguration of work area 100 and/or warehouse 200.

Station 250 may comprise or consist of the device 9 described above. Preferably but not exclusively, station 250 may comprise or consist of turret 10′.

Operationally, the steps of:
provision of a plurality of ultrasonic sensors 210 at each of the storage stations 201 to identify the occupied or vacant status of the same;
identification of the at least one batch L of products to be stored;
detection of the change in status from free to occupied of one of the storage locations 201 so as to determine the location of the at least one lot L.

The step of identifying the at least one lot L may be performed before, at the same time, or after the step of detecting the change in status from vacant to occupied. In other words, to determine the location of lot L it may be sufficient to receive data from the sensors 210 and from the one or more stations 250. Such data may then be processed in a manner in itself known since the identified lot L will be at location 201 that has changed status from vacant to occupied.

Eventually such identification and detection steps can be repeated for different L lots.

According to a particular form of implementation, the identification step may be carried out when the batch L of products is spaced from the warehouse 200. In other words, a time interval may be provided between the identification phase and the status change detection phase from free to occupied.

Preferably, the identification phase may be accomplished by a single identification station 250.

Regardless of the number of stations 250, the station 250 may comprise a receiving unit 15.

Appropriately, an emitter, preferably a beacon 20, associated with the lot L may be provided so that the identification of the lot L is accomplished by receiving a data packet from the beacon 20 analogous to that previously described with reference to the device 9.

Preferably, the number of stations 250 may be significantly less than the number of sensors 210 or a single station 250 and a plurality of sensors 210 may be provided. Such forms of implementation may be particularly suitable where there is a small number or a single access route to the warehouse 200, e.g., a single entrance door, a limited number of access routes such as shelf aisles.

It is understood that the system may equally comprise a large number of stations 250 without falling outside the scope of protection of the present invention. Eventually, the system may comprise a greater number of stations 250 than stations 201.

An example embodiment of a system 1 will now be described in detail, which may be particularly suitable for carrying out the steps described above.

System 1 may comprise at least one beacon 20 that may be associated with lot L. By association, it is meant that the beacon 20 may be placed at lot L. For example, the beacon 20 may be placed in the bin, on the pallet, on a product of the lot, or on other support media of the lot in a manner in itself known.

Preferably, but not exclusively, the beacon 20 may be removable so that it can be removed from the lot L.

The system may also include a receiving unit 15 for receiving the signal from the beacon 20, i.e., a data packet.

Similar to the above, the signal strength will be able to define an action area 101. In other words, receiving unit 15, beacon 20, and action area 101 may have the characteristics and operation described above for device 9. Specifically, as described above, the beacon 20 may send a data packet to a central unit 30 that may allow identification of the beacon 20 itself and/or the associated batch L. More specifically, a logical unit 16 operatively connected with the receiving unit 15 may be provided.

Appropriately, similar to what has been described above with reference to the support structure 10, the logical unit 16 may be configured to send data to the central unit 30 regarding:
presence or absence of the beacon 20 within the action area 101;
an identification code of beacon 20 if present.

This data, together with the data received from sensors 210 may be sufficient to determine the storage location of Lot L.

Because of this feature, the system may be particularly simple and reliable.

It is understood that a single receiving unit 15 and/or a single station 250 may be provided.

Possibly, advantageously, several stations 250 may be arranged, for example at the entrances to the industrial building, each with its own receiving unit 15 that can all be operationally connected with the central unit 30.

Appropriately, the logical unit 16 will be able to send to the central unit 30 additional data related to:
an identification code of the receiving unit 15;
possibly the position of the receiving unit 15 in the working area 100.

Such a configuration may be particularly suitable if there are a plurality of receiving units 15, e.g., in the case of a plurality of stations 250 each comprising its own receiving unit 15. In fact, in this way, in addition to the position in the warehouse, it will be possible to track the path of the batch L.

It is understood that this form of implementation is not exclusive. In fact, as described above, the number and location of stations 250 may be different as needed.

It is understood that the central unit 30 will be able to include a storage unit and/or a logical data-processing unit in its own known manner, and will be able to be operationally connected, preferably wirelessly, with stations 250 and sensors 210. The wireless connection will make it easy to install and move the stations 250.

Preferably, each station 250 may then comprise receiving unit 15 and logic unit 16, plus preferably a single receiving unit 15 and a single logic unit 16.

Suitably, once the lot L is placed at one of the stations 201, the central unit 30 may process the data from the station 250 and the sensors 210 to automatically determine the station 201 occupied by the identified lot L.

Preferably, all sensors 210 will be able to send live status data, and logic unit 30 will be able to recognize sensor 210 that has changed status.

On the other hand, the status change from free to occupied can be detected in any mode. For example, sensors 210 will only be able to send data to unit 30 when interrogated by the latter, or only the sensor 210 that changes state will be able to send data to unit 30.

According to a particular aspect of the invention, station 250 may include or consist of case 14 with logic unit 16, receiver unit 15 and possibly batteries/power supply and/or storage unit 17.

Eventually, station 250 may include the support structure 10 described above. For example, station 250 may include or consist of the turret 10′ described above.

In the latter case, system 1 may have all the advantages described above with reference to turret 10′, particularly in terms of versatility and reconfigurability.

A system comprising a plurality of stations 250 preferably a single station 250 each comprising a single device 9 has been described. For example, a case 14 or from a turret 10′ may define station 250.

On the other hand, according to a different embodiment, a single identification station 250 may comprise a plurality of devices 9 (e.g., a plurality of turrets 10′).

Advantageously, for some particular applications, a station 250 may comprise a large number of devices 9, e.g., in substantially the same number as sensors 210. For example, such a form of implementation will be particularly suitable for particularly bulky and distant objects such as beams or semi-finished products.

On the other hand, a station 250 will be able to include a number of devices 9 even greater in number than the number of sensors 210. Such an application may be particularly suitable in case there is a warehouse accessible from a plurality of positions. For example, in case the warehouse is an area of a yard accessible from all directions, or in case the warehouse is an object shelf accessible from all directions.

Eventually, the station 250 may comprise one or more devices 9 which comprise a plurality of receivers 15. For example, a row of a warehouse may be guarded by a single device 9 with a plurality of receivers 15, i.e., by means of a single action area 101.

In each case, the station 250 will be able to enable identification of the object or lot, while the sensors 210 will be able to detect the status of the respective station 201.

Because of the above, the same device 9 will be able to be used for multiple purposes within the 100 work area. For example, one and the same turret 10′ may first be placed on the yard so that area 101 covers the unloading area, for example, and then its position may be varied to place it near the entrance to the warehouse 200 so that area 101 covers the warehouse access threshold.

System 1 will thus be able to be particularly versatile.

Possibly, in the case where turret 10′ is placed in the vicinity of a machine M the threshold value of area extension 101 may be relatively high, e.g. determine an area radius of 1.5 m, while in the case where turret 10′ is placed in the vicinity of the entrance to warehouse 200 the threshold value of area extension 101 may be relatively low, e.g. determine an area radius of 3 m, in case the 10′ turret is placed in the vicinity of a hall or warehouse entrance yard 200 the threshold value of area extension 101 may be particularly low, e.g. determine an area radius of 20 m.

It is understood that a single central unit 30 will be able to be operationally connected with all devices 9 and sensors 210 so as to determine the location of lot L whether it is in the vicinity of machines M or in warehouse 200.

It is further understood that the central unit 30 will be able to include a storage unit to store the position of the lot L over time so as to enable tracking of the movements of the lot L.

The invention is susceptible to numerous modifications and variations, all of which are covered by the appended claims. All details may be replaced by other technically equivalent elements, and the materials may be different as needed, without departing from the scope of protection of the invention as defined by the appended claims.

The invention claimed is:

1-45. (canceled)

46. An automated system for tracking an object or batch of products within a work area, comprising:
at least one emitter asset tag configured to be uniquely associated with the object or batch of products;
at least one device comprising at least one receiving unit, the at least one device defining a first action area; and
a central unit operable with the at least one device,
wherein, when the at least one emitter asset tag is within the first action area, the central unit detects a presence of the at least one emitter asset tag.

47. The system according to claim 46, wherein the at least one device comprises a plurality of devices operatively connected with the central unit, the devices in the plurality of devices defining respective first action areas, the respective first action areas cooperating with each other to define a surveillance area of the object or batch of products within the work area.

48. The system according to claim 46, wherein the at least one device comprises a logical data processing unit operatively connected with the at least one receiving unit.

49. The system according to claim 48, wherein the central unit is operatively connected with each logical data processing unit such that each logical data processing unit sends first data to the central unit, the first data regarding:
presence or absence of the at least one emitter asset tag within the respective first action area;
an identification code of the at least one emitter asset tag, if present; and
an identification code of the at least one receiving unit or the device.

50. The system according to claim 46, wherein the at least one device has a second action area having an extent that is less than an extent of the first action area, the logical data processing unit of the at least one device being configured to send second data to the central unit regarding:
presence or absence of the at least one emitter asset tag within the respective second action area;
an identification code of the at least one emitter asset tag, if present; and
an identification code of the at least one receiving unit or device.

51. The system according to claim 49, wherein the logical data processing unit detects signal power received from the at least one receiving unit, and wherein, when the detected signal power is greater than a first predetermined threshold value, the at least one emitter asset tag is within the respective first action area, and, when the detected signal power is greater than a second predetermined threshold value, the at least one emitter asset tag is within the respective second action area.

52. The system according to claim 51, wherein the first predetermined threshold value and/or the second predetermined threshold values are predeterminable by an operator, so as to define an extent of the first action area and/or of the second action area.

53. The system according to claim 48, wherein the at least one device comprises a plurality of devices operatively connected with the central unit, and wherein at least one receiving unit comprises a plurality of receiving units all operatively connected to the same logical data processing unit.

54. The system according to claim 48, wherein the at least one device receives a signal from the at least one emitter asset tag when the at least one emitter asset tag is outside the first action area, the logical data processing unit sending third party data to the central unit, the third party data being related to an identification code of the at least one emitter asset tag.

55. The system according to claim 46, further comprising a support structure for the at least one device, the support structure comprising handling means for enabling an operator to move the at least one device in the work area between a first work position and a second work position.

56. The system according to claim 55, further comprising a movable turret comprising the support structure and the at least one device.

57. The system according to claim 49, wherein the work area comprises a storage area including a plurality of storage locations, the system further comprising:
a plurality of ultrasonic sensors placed at each storage location of the plurality of storage locations to detect a vacant or occupied status of each storage location,
wherein the central unit is operatively connected with the plurality of ultrasonic sensors to receive second data from each of the ultrasonic sensors regarding the vacant or occupied status of each storage location, and
wherein, after the object or batch of products is identified as placed in one of the storage locations, the central unit processes the second data to determine the sensor within the plurality of sensors has detected a change in the status from free to occupied, the storage location corresponding to the sensor being the location occupied by the object or batch of products identified with the first data received from the at least one device.

58. The system according to claim 57, further comprising an identification station of the object or batch of products, the identification station comprising the at least one device, the identification station being spaced from a warehouse such that the first action area is spaced from the warehouse.

59. The system according to claim 57, wherein the central unit comprises a storage unit for storing locations of the at least one emitter asset tag in a surveillance area and for storing a presence of the at least one emitter asset tag in the work area.

60. A method for tracking an object or batch of products within a work area comprising:
i. setting up a system according to claim 46 comprising the at least one device defining the first action area;
ii. placing the at least one device in a respective first operational position in the work area;
iii. arranging the central unit; and
iv. having the central unit receive data from the at least one device detecting a presence of the at least one emitter asset tag in the respective first action area so as to determine the respective first operational position in the work area of the object or batch of products.
